(19) United States
(12) Patent Application Publication
(10) Pub. No.: US 2016/0092310 A1
(43) Pub. Date: Mar. 31, 2016

(54) SYSTEMS AND METHODS FOR MANAGING GLOBALLY DISTRIBUTED REMOTE STORAGE DEVICES

(71) Applicant: Vivint, Inc., Provo, UT (US)

(72) Inventors: Alen Lynn Peacock, Orem, UT (US); Paul Cannon, American Fork, UT (US); Andrew Harding, American Fork, UT (US); John Timothy Olds, Sandy, UT (US); Thomas Jeffrey Stokes, Salt Lake City, UT (US); Jeffrey Michael Wendling, West Jordan, UT (US)

(21) Appl. No.: 14/503,022

(22) Filed: Sep. 30, 2014

(51) Int. Cl. G06F 11/14; G06F 9/44

(52) U.S. Cl. CPC G06F 11/1441; G06F 9/4416; G06F 2201/805

(57) ABSTRACT

Methods and systems are described managing module for remotely managing hardware of at least one of a plurality of distributed remote storage devices. A computer implemented method includes locally monitoring a system (including, for example, a core operating system) of the hardware, locally detecting an abnormal or unresponsive state of the system, generating a notice when the abnormal or unresponsive state is detected, delivering the notice to a remotely located central service, and automatically rebooting the hardware when the abnormal or unresponsive state is detected.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers has come an increased presence of in-home computing capability. As the prevalence and complexity of home computing systems and devices expand to encompass other systems and functionality in the home, opportunities exist for improved control of and access to such in-home systems and devices locally and remotely.

### SUMMARY

Methods and systems are described for remotely managing hardware of at least one of a plurality of distributed remote storage devices. An example computer implemented method includes locally monitoring a system (including, for example, a core operating system) of the hardware, locally detecting an abnormal or unresponsive state of the system, generating a notice when the abnormal or unresponsive state is detected, delivering the notice to a remotely located central service, and automatically rebooting the hardware when the abnormal or unresponsive state is detected.

In one example, automatically rebooting may occur after delivering the notice and the system includes a core operating system. The at least one of the storage devices may be controlled independently from control of the central service. The method may include providing permission for the central service to perform diagnostics on the at least one of the storage devices. The method may include receiving maintenance from the central service. The at least one of the storage devices and the central service may be part of a home automation system. The at least one of the storage devices may be part of a control panel of a home automation system.

Another embodiment is directed to an apparatus for remotely managing hardware of at least one of a plurality of distributed remote storage devices. The apparatus includes a processor, a memory in electronic communication with the processor, and instructions stored in the memory. The instructions are executable by the processor to locally monitor a system (including, for example, a core operating system) of the hardware, locally detect an abnormal or unresponsive state of the system, generate a notice when the abnormal or unresponsive state is detected, and automatically reboot the hardware when the abnormal or unresponsive state is detected.

In one example, the plurality of distributed remote storage devices may be controlled independently from control of the central service. The instructions may be executable by the processor to provide permission for the central service to perform diagnostics on the at least one of the storage devices. The instructions may be executable by the processor to receive maintenance from the central service.

A further embodiment is directed to a computer implemented method for remotely managing hardware of at least one of a plurality of distributed remote storage devices. The method includes receiving at a remotely located central service a notice when a system (including, for example, an operating or core operating system) of the hardware has been determined locally to be in an abnormal or unresponsive state, receiving permission from the at least one of the storage devices to create a control plane, initiating rebooting of the hardware after receiving notice of the abnormal or unresponsive state, and diagnosing the hardware via the control plane. The method may also include performing maintenance on the hardware via the control plane.

Another embodiment is directed to a computer implemented method for remotely updating software on a plurality of distributed remote storage devices. The method includes distributing a software update to a first group of the storage devices, the first group having a first trust level, and confirming operation of the software update on the first group. After confirming operation of the software update on the first group, the method includes distributing the software update to a second group of the storage devices, the second group having a second trust level less than the first trust level, confirming operation of the software update on the second group, and after confirming operation of the software update on the second group, distributing the software update successively to at least one additional group of the plurality of distributed remote storage devices until all remaining storage devices have received the software update.

In one example, the number of storage devices in the first group may be less than the number of storage devices in the second group and the at least one additional group. Distributing the software update successively to the at least one additional group may include an automatic staged random delivery process. The automatic staged random delivery process may include controlling what percentage of the remaining storage devices receives the software update in a given time window and recording the percentage centrally. The method may include distributing another software update to the first group after confirming operation of the software update on the first group and before the software update has been distributed to all of the remaining storage devices. The method may include distributing multiple software updates simultaneously.

Another embodiment is directed to an apparatus for remotely updating software on a plurality of distributed remote storage devices. The apparatus includes a processor, a memory in electronic communication with the processor, and instructions stored in the memory. The instructions are executable by the processor to distribute a software update to a first group of the storage devices, the first group having a first trust level, and confirm operation of the software update on the first group. After confirming operation of the software update on the first group, the apparatus distributes the software update to a second group of the storage devices, the second group having a second trust level less than the first trust level, and after distributing the software update to the second ground, distribute the software update successively to at least one additional group of the plurality of distributed remote storage devices until all remaining storage devices have received the software update.

In one example, the number of storage devices in the first group may be less than the number of storage devices in the second group and the at least one additional group. Distributing the software update successively to the at least one additional group may include an automatic staged random delivery process. The automatic staged random delivery process may include controlling what percentage of the remaining storage devices receives the software update in a given time window and recording the percentage centrally. The instructions may be executable by the processor to distribute another software update to the first group after confirming operation of the software update on the first group and before the software update has been distributed to all of the remaining storage devices. The instructions may be executable by the processor to retrieve the software if the software does not meet operation specifications.

Another embodiment is directed to a computer implemented method for remotely diagnosing at least one of a plurality of distributed remote storage devices. The method includes receiving authorization locally from a user of the at least one of the storage devices, communicating identification information for the at least one of the storage devices to a central service, permitting creation of a control plane between the central service and the at least one of the storage devices based on the identification information, and receiving a diagnosis for the at least one of the storage devices via the control plane.

In one example, communicating identification information includes periodically sending communications from the at least one storage device to the central service. Communicating identification information may occur automatically upon receiving authorization locally from the user. Receiving authorization locally from the user may occur at set up of the at least one of the storage devices. The control plane may include remote control of the at least one of the storage devices by the central service. The method may include auditing tasks performed by the central service via the control plane. The control plane may include a secure shell (SSH) protocol.

Another embodiment is directed to an apparatus for remotely diagnosing at least one of a plurality of distributed remote storage devices. The apparatus includes a processor, a memory in electronic communication with the processor, and instructions stored in the memory. The instructions may be executable by the processor to receive authorization locally from a user of the at least one of the storage devices, communicate identification information for the at least one of the storage devices to a central service, permit creation of a control plane between the central service and the at least one of the storage devices based on the identification information, and receive at least one of a diagnosis and maintenance for the at least one of the storage devices via the control plane.

In one example, communicating identification information may occur automatically upon receiving authorization locally from the user. The control plane may provide remote control of the at least one of the storage devices by the central service. The control plane may include a secure shell (SSH) protocol.

A further embodiment is directed to a computer implemented method for remotely diagnosing at least one of a plurality of distributed remote storage devices. The method includes receiving pre-authorized identification information for the at least one of the storage devices via periodic communications from the at least one of the storage devices, creating a control plane with the at least one of the storage devices based on the identification information, and diagnosing the at least one of the storage devices via the control plane.

In one example, the control plane may include remote control of the at least one of the storage devices. The control plane may include a secure shell (SSH) protocol.

Another embodiment is directed to a computer implemented method for locally diagnosing at least one of a plurality of distributed remote storage devices. The method includes determining whether a boot up procedure for a hard drive of the at least one of the storage devices occurs, locally automatically generating a diagnosis for the at least one of the storage devices, automatically delivering the diagnosis to a remotely located central service, permitting creation of a control plane between the at least one of the storage devices and the central service, and communicating between the at least one of the storage devices and the central service via the control plane.

In one example, the method includes initiating a boot up procedure for a system (including, for example, an operating or core operating system) of the at least one of the storage devices, and initiating the boot up procedure for a hard drive of the at least one of the storage devices, wherein the diagnosis relates to a failure of the hard drive to boot up. The method may include receiving confirmation of the diagnosis from the central service. The method may include receiving maintenance from the central service via the control plane.

A further embodiment relates to an apparatus for locally diagnosing at least one of a plurality of distributed remote storage devices. The apparatus includes a processor, a memory in electronic communication with the processor, and instructions stored in the memory. The instructions may be executable by the processor to determine whether a boot up procedure for a hard drive of the at least one of the storage devices occurs, automatically locally generate a diagnosis for the at least one of the storage devices, permit creation of a control plane between the at least one of the storage devices and the central service, and communicate between the at least one of the storage devices and the central service via the control plane.

In one example, the instructions may be executable by the processor to initiate a boot up procedure for a system (including, for example, an operating or core operating system) of the at least one of the storage devices, and initiate the boot up procedure for a hard drive of the at least one of the storage devices, wherein the diagnosis relates to a failure of the hard drive to boot up. The instructions may be executable by the processor to receive from the central service confirmation of the diagnosis via the control plane. The instructions may be executable by the processor to receive maintenance from the central service via the control plane.

Another embodiment is directed to a computer implemented method for locally diagnosing at least one of a plurality of distributed remote storage devices. The method includes receiving a locally generated diagnosis for the at least one of the storage devices based on a boot up procedure for a hard drive of the at least one of the storage devices, creating a control plane with the at least one of the storage devices based on the diagnosis, and communicating with the at least one of the storage devices via the control plane.

In one example, the diagnosis may relate to a failure of the hard drive to boot up. The method may include transmitting confirmation of the diagnosis to the at least one of the storage devices. The method may include providing maintenance for the at least one of the storage devices via the control plane.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of another environment in which the present systems and methods may be implemented;

FIG. 3 is a block diagram of another environment in which the present systems and methods may be implemented;

FIG. 4 is a block diagram of another environment in which the present systems and methods may be implemented;

FIG. 5 is a block diagram of another environment in which the present systems and methods may be implemented;

FIG. 6 is a block diagram of a managing module of at least one of the environments shown in FIGS. 1-5;

FIG. 7 is a block diagram of a managing module of at least one of the environments shown in FIGS. 1-5;

FIG. 8 is a block diagram of a managing module of at least one of the environments shown in FIGS. 1-5;

FIG. 9 is a flow diagram illustrating a method for remotely managing hardware of at least one of a plurality of distributed remote storage devices;

FIG. 10 is a flow diagram illustrating another method for remotely managing hardware of at least one of a plurality of distributed remote storage devices;

FIG. 11 is a flow diagram illustrating another method for remotely managing hardware of at least one of a plurality of distributed remote storage devices;

FIG. 12 is a flow diagram illustrating a method for remotely updating software on a plurality of distributed remote storage devices;

FIG. 13 is a flow diagram illustrating another method for remotely updating software on a plurality of distributed remote storage devices;

FIG. 14 is a flow diagram illustrating a method for remotely diagnosing at least one of a plurality of distributed remote storage devices;

FIG. 15 is a flow diagram illustrating another method for remotely diagnosing at least one of a plurality of distributed remote storage devices;

FIG. 16 is a flow diagram illustrating another method for remotely diagnosing at least one of a plurality of distributed remote storage devices;

FIG. 17 is a flow diagram illustrating another method for remotely diagnosing at least one of a plurality of distributed remote storage devices;

FIG. 18 is a flow diagram illustrating a method for locally diagnosing at least one of a plurality of distributed remote storage devices;

FIG. 19 is a flow diagram illustrating a method for locally diagnosing at least one of a plurality of distributed remote storage devices; and

FIG. 20 is a block diagram of a computer system suitable for implementing the present systems and methods of FIGS. 1-19.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to remote management of computing resources, and more particularly to the remote management devices, containing both storage capacity and computing capacity. The devices may be distributed geographically, such as being distributed across the globe. The devices are typically not physically accessible, but rather are controlled by individual users in a home or small business setting.

It is typical for computing services to be housed in data services, with the capability for operators to manage every aspect of individual computing resources remotely via mechanisms built into computer operating systems or third party management software. Such systems often provide a remote console for issuing commands, as well as mechanisms for automating the running of the same set of commands across multiple machines. Via these mechanisms, an operator in another part of town, or even halfway across the world or another remote geographic area, may perform upgrades and maintenance on systems without needing to be in the same physical room as the equipment. Data centers provide uniform access to networking, power, cooling, etc., and usually have staff on hand to assist remote operators by, for example, power-cycling systems for reconnecting equipment. The combination of remote management tools and on-hand staff makes it possible to perform all necessary management operations without being physically present.

The systems and methods disclosed herein involve placement of storage assets out of the data center and into people's homes or small businesses. Devices in users' homes are combined to form a cooperative storage fabric in which individual devices trade and/or share resources to protect data from being lost. These devices may need to be updated remotely, have remote diagnosis performed thereon, and, in some case with the permission of the device owner, enable direct remote management capabilities. The number of challenges arise when equipment, such as the storage assets disclosed herein, are not centralized in data centers.

First, remote management equipment outside of data centers, such as in people's homes, may require additional effort. Devices in homes may not be continuously connected, and may not be online when an update is sent. In-home devices may sit disconnected for many days, weeks or months, and then reappear online and need to be caught up from a software perspective. Such storage devices having non-uniform access to bandwidth, and even those that are powered on and connected, may have inconsistent reachability over the network. Additionally, remote management, including software updates, typically must treat consumers own networks with great care so as not to use too many resources (e.g., mainly bandwidth) while the users are trying to dedicate those resources to other uses (e.g., streaming video content).

Second, for devices possessed, operated, or owned by consumers rather than data centers, granting access to remote operators may raise various securities, privacy, and ownership issues. Balancing those issues with the ease of use and the ability to quickly react to problems, remotely, may require delicate and deliberate architectural decisions.

Third, devices in consumers' homes are typically low power and low memory, thereby putting additional strain on the underlying operating system of the devices. As a result, the load on the system may be likely to push the systems of the individual devices over a responsiveness edge into a state where the device and/or system may no longer be remotely manageable or able to update/diagnose itself.

Fourth, if a remote upgrade goes poorly, and there is no person physically present and available to undo the damage by reflashing the software, power cycling the equipment (e.g., rebooting), or the like.

In view of these challenges, it may be desirable to provide a remote management system, such as the systems and methods disclosed herein, for use with devices located in peoples' homes and which are spread across wide geographic areas such as across the globe. The remote management system may provide, for example, the devices with automatic updates to the latest software versions available when the devices are plugged in, the system/devices may be self-checked for configuration updates when needed, and other advantageous functions. The several system mechanisms, devices and methods of the present disclosure, when used individually or in combination, may assist users to, among other things, connect their storage devices online where the device can self-update, self-diagnosis and benefit from other remote management capabilities.

One aspect of the present disclosure relates to incorporating a hardware-based heartbeat monitor with custom software to detect if and when the operating system of the device has become responsive. The device may include, for example, a storage device configured to store data associated with the individual user who owns the device and who may also provide storage capacity for other remotely positioned storage devices as part of a peer-to-peer storage network. The heartbeat monitor may largely take the place of physical staff which may otherwise be required to reset the systems of the device. Most modern operating systems do not reach a state of complete unresponsiveness, especially on server-grade hardware. In a system designed to lower storage costs with low memory and low power embedded systems, such as those included in the in-home storage devices disclosed herein, it is usually much easier to push the system into a state of unresponsiveness. Employing a hardware monitor that can watch the system and detect when it becomes unresponsive may mitigate one or more of the main reasons for needing physical staff present, such as in a data center, as described above.

Another aspect of the present disclosure relates to a remote software updater, which may run at scheduled intervals, for example, to poll for software updates, retrieve the updates, and apply the updates locally. Each storage device in the network may determine its own time at which to perform this check/update process. These storage devices may be segregated into several different levels or groups, which determine how quickly the storage devices will get updated and how widespread the updates will be deployed. These levels or groups (e.g., 1-N) go from a small handful of devices (e.g., at Level 1) to all devices (e.g., at Level N). Level 1 is typically a group of storage devices that the company has physical access to, either onsite or in employees' homes. The software upgrades are first deployed to Level 1 and then allowed a set amount of time, for example, to test that the updates are operating with the update as expected, and/or the devices do not have issues with the update that render the updates impossible to remotely manage. Once the operational team has a desired level of confidence in the upgrade for Level 1, the upgrade may proceed to Level 2. Level 2 may include a slightly wider rollout than Level 1, with devices at “arm's length” from the company, such as people who are friends, family, or enthusiastic users who may be relied upon to help repair problems with software upgrades if needed, provide meaningful feedback, and/or permit open access to the devices. After Level 2, rollout may extend gradually or concurrently to the entire population of storage devices in the network. An automatic staged granted delivery process may be used, wherein the system controls what percentage of devices at large receive the updates in each time window and records that information centrally. The rollout process may be halted at any point, and the updates that have already been deployed may be reversed or recalled. Multiple versions of software may be rolled out through this deployment pipeline simultaneously. For example, if the software and the system are at Version 7, and a Version 8 has been tested at Levels 1 and 2, Version 8 may be deployed to the system at large in stages as described above, and Version 9 may start being tested at Levels 1 and/or 2.

Another aspect of the present disclosure relates to an optional remote console with limited access and diagnostic capability that can be enabled by a device's owner to permit a technician to remotely diagnose and operate basic functionality of the storage device. This mechanism may be triggered when, for example, the user authorizes access locally on their device, and/or the device pings a central service with identification information that allows the remote creation of a control plane into the device itself. The control plane of the device can be provided by several mechanisms including, for example, a program that executes local commands remotely and returns the results over the network. The program may be limited in the types and extent to which remote commands may be executed in this manner.

A further aspect of the present disclosure relates to a mechanism that provides limited diagnostic output in the case where other problems prevent the system from functioning normally. For example, if the hard drive attached to the device, which contains the devices operating system and device software, has failed or malfunctioned, certain basic diagnostic and/or limited remote counsel functionality can still be provided by the firmware.

These and other mechanisms, devices and functionality included in the present disclosure may provide a platform that allows devices (e.g., in-home storage devices) to be remotely diagnosed and repaired, and may reduce the number of devices that must be returned for service.

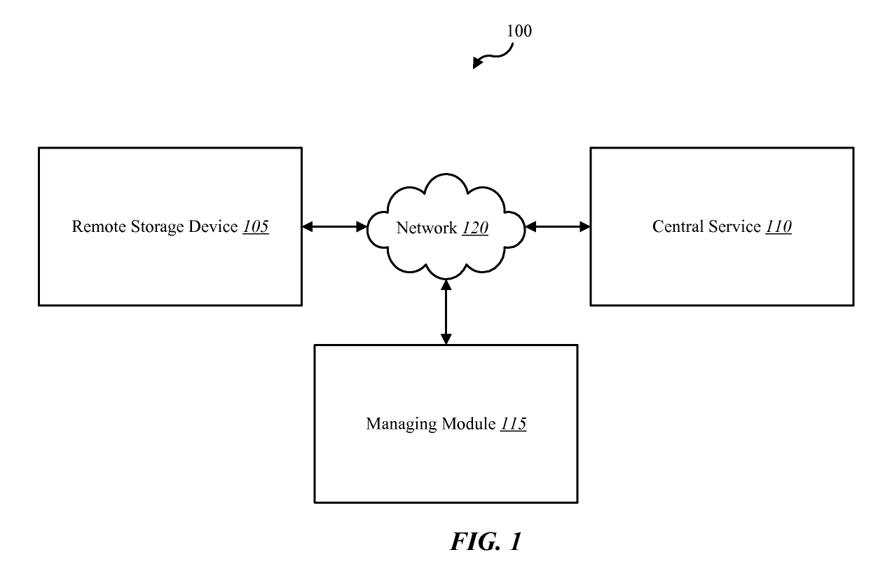

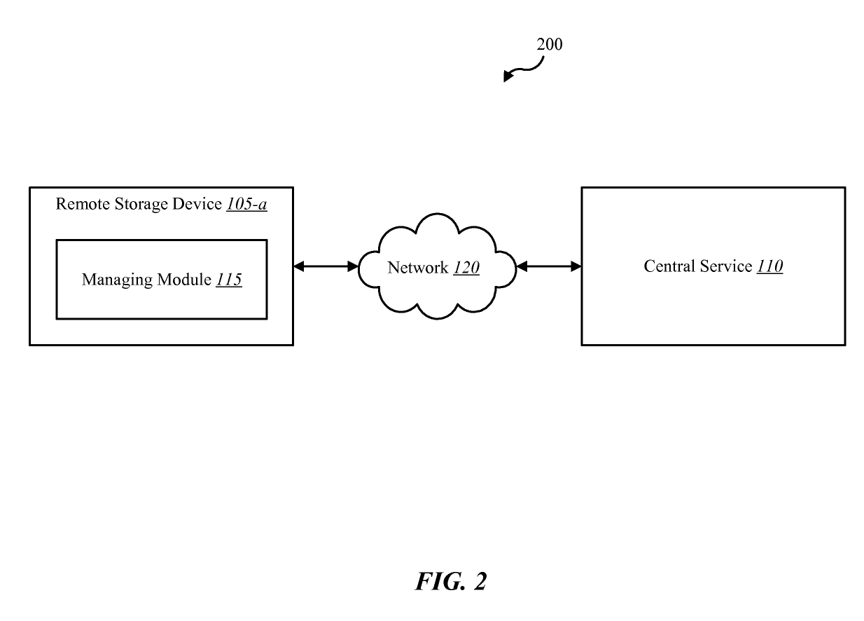

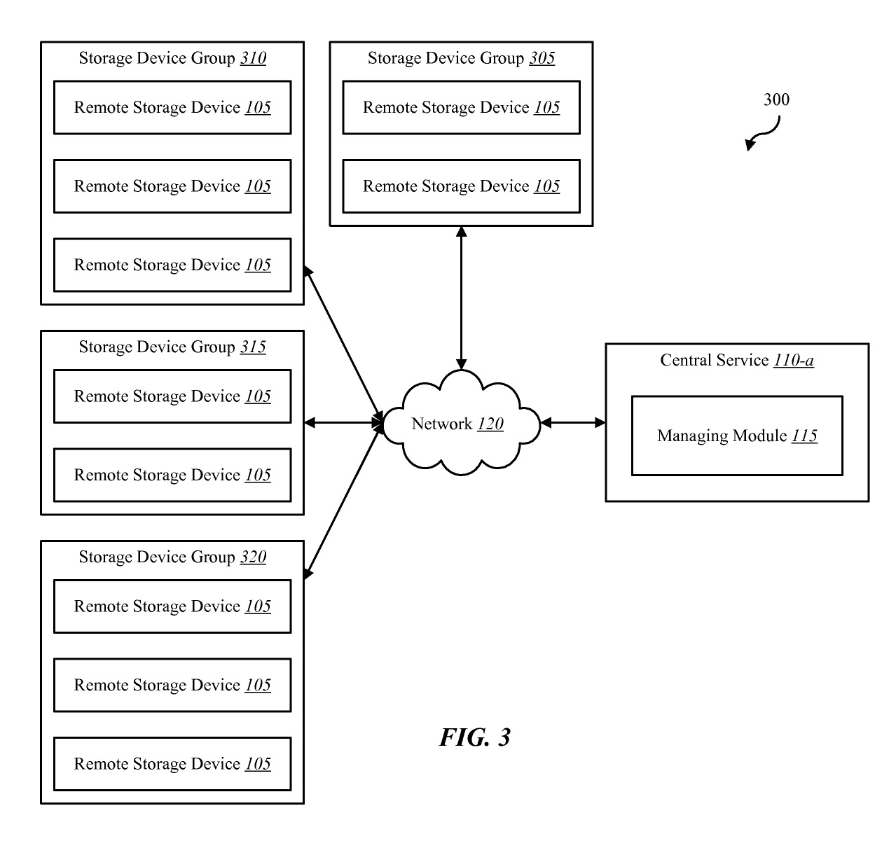

FIG. 1 is a block diagram illustrating one embodiment of environment 100 in which the present systems and methods may be implemented. In some embodiments, the systems and methods described herein may be performed at least in part on or using a remote storage device 105, a central service 110, and a managing module 115, which may communicate with each other via a network 120. Although managing module 115 is shown as a separate component from remote storage device 105 and central service 110, in other embodiments (e.g., the embodiments described below with reference to FIG. 2 and/or FIG. 3), managing module 115 is integrated as a component of remote storage device 105 or central service 110. In some embodiments, monitoring module may be positioned in a common housing with one or more of remote storage device 105 and central service 110, or are at least operable without intervening network 120.

The environment 100 may be referred to as a distributed system or cross-storage system having some sort of remote management capability. The remote management capability may be provided by making at least one of the remote storage device 105 and central service 110 accessible remotely to provide, for example, software updates, maintenance and other services for the remote storage devices 105 without the need for a person on-site to physically handle or operate (e.g., reboot, etc.) remote storage device 105.

Environment 100 may be operable to perform all or any part of the several embodiments described above including, for example, the heartbeat monitor, the remote software updater, the remote counsel with limited access and diagnostic capability, and/or the mechanism that provides limited diagnostic output in the case where other problems prevent the system from functioning normally. In the case of the heartbeat monitor, managing module 115 may monitor operation of remote storage device 105. In the event that a system (including, for example, an operating or core operating system) of remote storage device 105 becomes damaged or is defective, or a process that runs on remote storage device 105 in a way that consumes available memory or makes the operating system unacceptably slow, and the heartbeat monitor of managing module 115 may detect the conditions and, for example, reboot the remote storage device 105 automatically. The automatic rebooting of remote storage device 105 as initiated by managing module 115 may assist in cases where remote storage device 105 is unresponsive and/or inaccessible remotely or even locally. Managing module 115 operates to automatically control at least some aspects of remote storage device 105 (e.g., rebooting) even when remote storage device 105 is not under physical control of central service 110 (e.g., remote storage device 105 is located in a user's home and accessible physically only by the user).

In one example of a heartbeat monitor, managing module 115 monitors how many times the remote storage device 105 is automatically rebooted and stops a cycle of automatic rebooting if a certain number of reboots has occurred or the remote storage device 105 remains unresponsive after a certain period of time has lapsed.

In the embodiment of the remote counsel with limited access and diagnostic capability, managing module 115 operates to determine a status of remote storage device 105 (e.g., determine if something has gone wrong with the device or is looking for diagnosis of a specific problem for a specific user). Managing module 115 may permit a remote operator (e.g., a technical support person at central service 110) to remotely see what is going on at remote storage device 105 such as by reviewing logs, analyzing status indicators, running diagnostic tests, etc. Generally, managing module 115 provides a higher degree of control over remote storage device 105 remotely than would be possible otherwise when remote storage device 105 is positioned physically within a user's home and connected as part of the users home computer network (e.g., including firewalls and other security measures).

The action to provide the remote management provided by managing module 115 may be initiated at remote storage device 105. In many cases, remote storage device 105 is positioned in a user's home and behind a network address translator or firewall (e.g., isolated from remote contact by central service 110 even if the user provides an IP address for remote storage device 105). Remote storage device 105, alone or by operation of managing module 115, may reach out to and establish a connection with a management service provided by managing module 115 and/or central service 110. Once the connection has been made, which may be referred to as a control plane, the operator at central service 110 may be able to access remote storage device 105 over the control plane. The control plane may also be referred to as a management tunnel. Remote storage device 105 may operate to constantly or at least periodically ping the management service and tell the management service that the remote storage device 105 exists and makes possible, via an enabling operation, creation of control plane and access to remote storage device 105. Managing module 115 may operate separately from or integrally with remote storage device 105 to provide the authorization via an active outreach and/or handshake from remote storage device 105 to central service 110 to permit the desired access for central service 110 to remote storage device 105 for purposes of, for example, diagnosis, maintenance, rebooting, and the like.

In one example, the control plane may be implemented using a permissive form such as, for example, a remote console that is using a secure shell (SSH) protocol. Other types of control planes having greater restrictions may also be used, but may be limited to certain commands and/or capability. Still further types of control planes may be generated that allow the user, whose control of the remote storage device 105, to audit what the central service 110 and/or managing module 115 has performed and/or executed on the remote storage device 105. Some types of control planes may permit the user to watch in real-time the functions and operations conducted by central service 110 on remote storage device 105 via, for example, managing module 115. Typically, the user, via manual operation of remote storage device 105 or a preset feature or functionality of remote storage device 105, provides authorization and/or initiates control of remote storage device 105 by central service 110.

In the embodiment of the mechanism that provides limited diagnostic output in the case where other problems prevents the system from functioning normally, the device may include two separate operating systems that are bootable from the same device. One of the operating systems may be associated with a hard drive of the device. The other operating system may be associated with other functionality of remote storage device 105. In the event that the hard drive of remote storage device 105 is damaged or becomes unresponsive, the remote storage device 105 may still be able to boot up and/or provide some minimal communication capability with central service 110 via operation of managing module 115. For example, remote storage device 105 may be able to reboot, at least in part, even in the absence of booting of the hard drive or complete elimination of the hard drive based on an incorrect firmware image (e.g., an image without operability of the hard drive) while still providing some limited capability to perform some of the other functions possible for remote storage device 105. For example, booting up of the operating system of remote storage device 105 without booting up the hard drive may still permit collecting of some diagnostics, creation of a remote control plane with central service 110, and communication of diagnostic information to a remote location such as central service 110. Managing module 115 may provide the operability of remote storage device 105 under these conditions as well as at least some of the communications between remote storage device 105 and central service 110.

In some examples, once a remote control and/or management plane is established between central service 110 and remote storage device 105, regardless of the operating state of the hard drive of remote storage device 105, a number of functions and/or services may be provided via, for example, managing module 115. In one embodiment, central service 110 is able to diagnose problems with remote storage device 105, which diagnosis will assist in how remote storage device 105 is repaired either locally or upon delivery of remote storage device 105 for repair.

Managing module 115 as shown in environment 100 may be operable separately and independently from remote storage device 105, central service 110 and/or network 120. In other embodiments, at least some features and functionality of managing module 115 may be operable on or in close association with either or both of remote storage device 105 and central service 110. In some examples, managing module 115 may provide at least some of the communications between remote storage device 105 and central service 110 via network 120.

In at least some embodiments, environment 100 may include or be part of a home automation system and/or a home automation and security system. Remote storage device may be part of, for example, a control panel or other data storage and/or control component of such an home automation system. In other examples, the remote storage device 105 may communicate with a control panel of the home automation system and may be positioned in the same building (e.g., home) as the control panel. The central server 110 may be part of or be controlled by a central station of the home automation system.

FIG. 2 is a block diagram illustrating one embodiment of an environment 200 in which the present systems and methods may be implemented. Environment 200 may include at least some of the components of environment 100 described above. Environment 200 may include managing module 115 as part of a remote storage device 105-a. Remote storage device 105-a may communicate with central service 110 via network 120. Managing module 115 may be a component of and/or may be intricately formed as part of remote storage device 105-a (e.g., located in a common housing, operable using a common power source and/or operating system, and the like).

FIG. 3 is a block diagram illustrating one embodiment of an environment 300 in which the present systems and methods may be implemented. Environment 300 may include at least some of the components of environments 100, 200 described above. Environment 300 may include a plurality of remote storage devices 105 that communicate with a central service 110-a via network 120. Central service 110-a may include managing module 115. Managing module 115 may be a component of and/or may be integrally formed as a part of central service 110-a (e.g., house with a common housing, operable using a common power source or operating system, and the like).

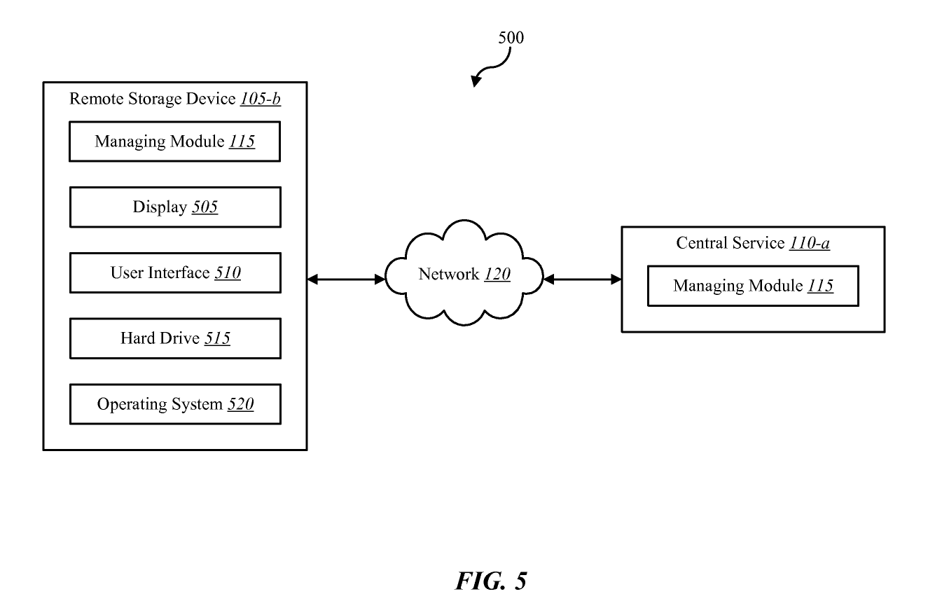

FIG. 3 also shows a plurality of storage device groups 305, 310, 315, 320 that each include a plurality of remote storage devices 105. Environment 300 may be particularly useful for performing the remote software updating embodiment described above. In some examples, at least portions of managing module 115 may be included on each of the remote storage devices 105, and at least some portions of managing module 115 may be included with central service 110-a (e.g., see FIG. 5).

Each of the remote storage devices 105 may include a software update mechanism that periodically checks to see if there are new versions of software to receive from central service 110-a. Remote storage device 105 may download the software updates and apply the updates locally on each individual storage device 105. Managing module 115 may operate to rollout the software update to less than all of the storage device groups 305, 310, 315, 320 concurrently as an alternative to concurrently making software updates generally available to all of remote storage devices 105 in environment 300. Managing module 115 may make the software updates available to only a limited number of the remote storage devices 105 based on which of the storage device groups 305, 310, 315, 320 the remote storage device 105 its grouped with. This rollout of software updates may be referred to as a staged rollout. The staged rollouts may be at least partially automated based on, for example, a schedule of the percentage of remote storage devices 105 in each stage of the rollout, the amount of control desired for a given remote storage device 105 to which the software update is made available to, the ability to retrieve damaged software for any reason, geographic considerations, and the like. The time spacing between each phase or group of remote storage devices 105 for rolling out the software may be compressed or extended for any desired purpose including, for example, the level of confidence that the software will properly operate for a given group of remote storage devices 105.

The rollout of software updates as controlled by managing module 115 may first be made available to storage device group 305. Storage device group 305 may include remote storage devices 105 that are identified as, for example, testing devices that are under physical control of the network operators. The remote storage devices 105 of storage device group 305 may reside, for example, in the place of business for the network operators or in the homes of employees of the company that operates the network. The remote storage devices 105 of storage device group 305 are monitored closely to confirm that the software update is operating properly on remote storage devices 105, or at least long enough to provide a certain level of certainty that the software will work properly for other of the remote storage devices (e.g., it is okay to rollout the software updates to additional storage device groups).

The second storage device group 310 to which the software update is made available may include another class or level of remote storage devices 105. The second class or level may include, for example, remote storage devices 105 possessed by friends and family of the company and/or enthusiasts of the product who can provide at least some feedback in the event that the software update does not operate properly on their remote storage device 105. The storage device group 310 may provide an advantage of being able to more easily pull back the software update if necessary, or to make personal contact with the owner of remote storage device 105 to perform certain tasks at the remote storage device 105, etc. In some examples, those in the storage device group 310 may be able to use their remote storage device 105 at no cost in exchange for providing the desired feedback, increased access to, and possible conducting of physical tasks associated with remote storage device 105.

After the software update is confirmed with a certain level of confidence that the software is operating properly on the remote storage device 105 of storage device group 310, managing module 115 may rollout the software updates to the general population of remote storage devices 105. The general population may receive the software update in multiple deployments such as first to storage device group 315 and after at least some delay to the storage device group 320. The priority for rolling out the software update to the general population may be based on certain criteria such as, for example, relative geographic proximity to central service 110-a or other geographic considerations, a purchase date for the remote storage device 105 and/or when the remote storage device 105 was brought online in the network, the version or state of the existing software (e.g., lower versions being given a higher priority for the software update than more recent versions), or by random selection based on when the individual remote storage device 105 pinged the central service 110-a for software updates.

The rollout of software updates via central service 110-a and managing module 115 may be based at least in part on, for example, a level of trust, a level of control of the remote storage device 105, or the like. For example, as described above, the remote storage devices 105 of storage device group 305 may be under complete control of the network operators, while the remote storage devices 105 of storage device group 310 may have less control because they are positioned in people's homes, albeit it friends, family or enthusiasts of the product, which may provide additional control and/or trust for remote storage devices 105 of storage device group 315.

As mentioned above, managing module 115 may be operable to withdraw or recall the software update for any reason after the software update has been delivered, downloaded, or at least partially implemented on any one of the remote storage devices 105. The ease or complexity involved in doing a recall of a software update may correlate with the trust and/or control level for the various storage device groups 305, 310, 315, 320.

The staged rollout of software updates may make it possible to concurrently rollout multiple software update versions. For example, a software update Version 7 may be in a staged rollout in storage device groups 315 and 320 while a Version 8 may be undergoing testing and implementation with the remote storage devices of storage device group 310, and a Version 9 may be being tested and under review on the remote storage devices of storage device group 305. The rollout process for any given software update may require hours, days, weeks or months. The time delay between rolling out the software update for each given level or group of remote storage devices may influence the ability and frequency possible for implementing multiple software updates concurrently.

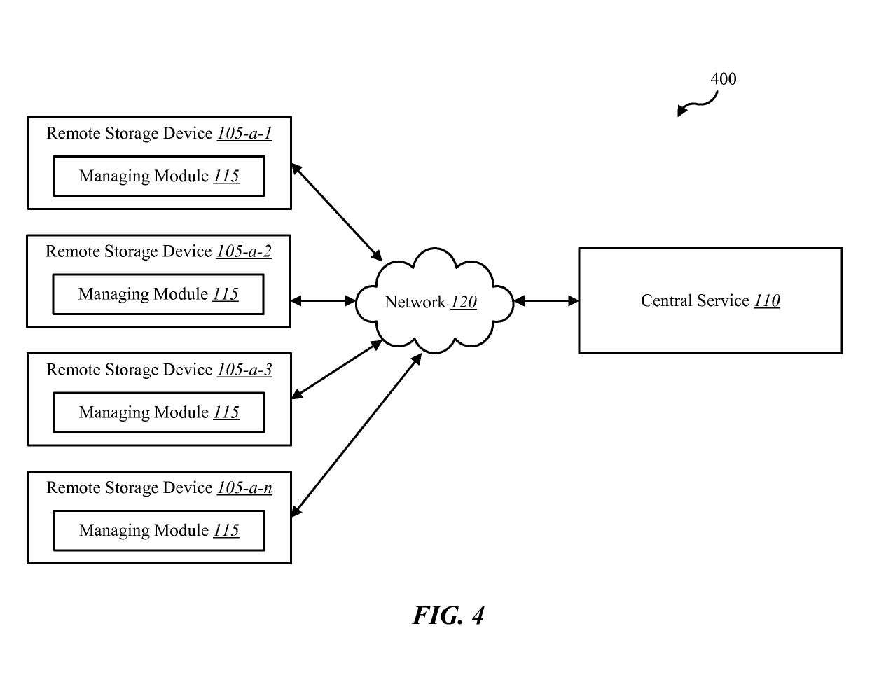

FIG. 4 is a block diagram illustrating one embodiment of an environment 400 in which the present systems and methods may be implemented. Environment 400 may include at least some of the components of environments 100, 200, 300 described above. Environment 400 may include a plurality of remote storage devices 105-a that each include a separate managing module 115. All of the remote storage devices 105-a may communicate independently with a central service 110 via network 120. In some embodiments, central service 110 additionally includes a separate managing module 115, or at least a portion of the managing module 115 operable on remote storage devices 105-a is operable on or in some way associated with central service 110.

Providing a separate managing module 115 on each of the remote storage devices 105-a may make it possible to separately operate and control desired communications, software updates, diagnostics, maintenance, and other communications between each of the remote storage devices 105-a and central service 110. In some examples, the managing modules 115 of each remote storage device 105-a may be in communication with each other via network 120 as well as being in communication with central service 110. Remote storage devices 105-a may communicate with each other via the managing module 115.

FIG. 5 is a block diagram illustrating one embodiment of an environment 500 in which the present systems and methods may be implemented. Environment 500 may include at least some of the same components as environments 100, 200, 300, 400 described above. Environment 500 may include a remote storage device 105-b that communicates with central service 110-a via network 120. Remote storage device 105-b may include managing module 115, a display 505, a user interface 510, a hard drive 515, and an operating system 520. Central service 110-a may additionally include managing module 115 or at least portions thereof.

Display 505 may include, for example, a digital display for remote storage device 105-b. Display 505 may be provided via other devices coupled in electronic communication with remote storage device 105-b including, for example, a desktop computer or mobile computing device. In at least some examples, display 505 may include user interface 510. User interface 510 may include a plurality of menus, screens, microphones, speakers, cameras, and other capability that permit interaction between the user and remote storage device 105-b, or components thereof. Additionally, or alternatively, user interface 510 may be provided as a separate device or feature from remote storage device 105. Display 505 and/or user interface 510 may provide for user input of instructions, permissions, diagnostic information, device performance data, and the like as part of operating the devices, systems and methods of environment 500.

Hard drive 515 may provide data storage capability for remote storage device 105-b. Hard drive 515 may have a separate and distinct operating system and/or boot up capability from the remaining features and functionality of remote storage device 105-b, in particular operating system 520. Operating system 520 may be separately controllable and bootable relative to hard drive 515. In some embodiments, such as the mechanism described above having limited diagnostic output in the case where the problems prevent the system from functioning normally, the hard drive 515 may boot up and be operable separate from booting up from operating system 520 and other functionality of remote storage device 105-b. Remote storage device 105-b may operate to perform at least some functions independent of operation of hard drive 515.

Hard drive 515 may be partitioned into separate portions or segments used for storing data from different sources. One portion or segment of hard drive 515 may be available for storing data for the owner/operator of remote storage device 105-b. Other portions or segments of hard drive 515 may be made available for storage of data from other remote storage devices 105 to provide, for example, a backup for the data separately stored on other remotely located remote storage devices 105.

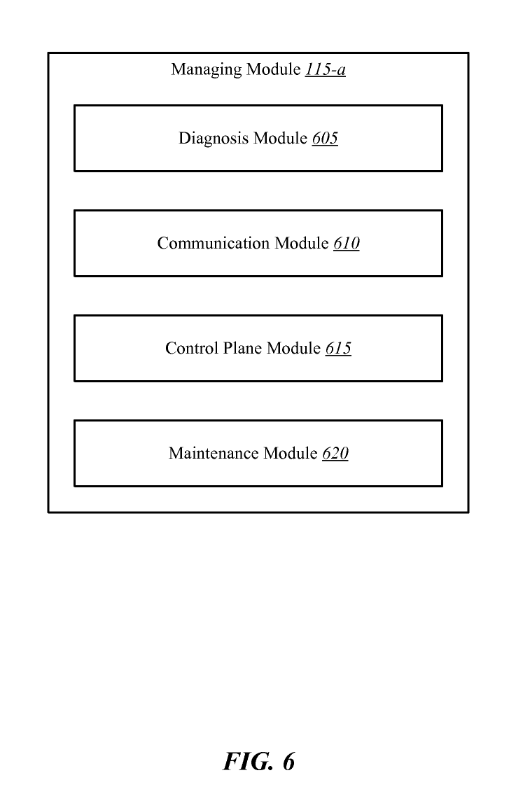

FIG. 6 is a block diagram illustrating an example managing module 115-a. Managing module 115-a may be one example of the managing module 115 described above with reference to FIGS. 1-5. Managing module 115-a may include a diagnosis module 605, a communication module 610, a control plane module 615, and a maintenance module 620. In other examples, managing modules 115-a may include more or fewer of the modules shown in FIG. 6.

Diagnosis module 605 may operate to self-diagnose remote storage device 105. Diagnosis may relate to, for example, an abnormal or unresponsive state of a system (including, for example, an operating or core operating system) of the remote storage device 105, a problem associated with a hard drive of a remote storage device 105 (e.g., a failure to boot up or lack of responsiveness thereof), or a problem with a software update or compatibility of a software update on the remote storage device. Additionally, or alternatively, diagnosis module 605 may operate to diagnose one or more issues related to a remote storage device from a remote location such as, for example, the central service 110 described above. In at least one environment, a user is required to provide permission or authorization for access to the remote storage device 105 from a remote location such as, for example, the central service 110.

Communication module 610 may provide communication between remote storage device 105 and central service 110. Communication module 610 may provide one-way or two-way communications. The communications may be made via, for example, network 120. Network 120 may utilize any available communication technology such as, for example, Bluetooth, Zigby, Z-wave, infrared (IR), radio frequency (RF), near field communication (NFC), or other short distance communication technologies. In other examples, network 120 may include cloud networks, local area networks (LAN), wide area networks (WAN), virtual private networks (VPN), wireless networks (using 802.11 for example), and/or cellular networks (e.g., using 3G and or LTE), etc. In some embodiments, network 120 may include the internet.

Control plane module 615 may facilitate generation and operation of a control plane or management tunnel between remote storage device 105 and central service 110. Control plane module 615 may provide creation of a control plane after permission is provided by remote storage device 105, a user of the remote storage device, or automatically based on settings or pre-determined functionality as set up by a user or authorized by a user of remote storage device 105 (e.g., pre-authorization. The control plane established by control plane module 615 may facilitate diagnosis, maintenance, rebooting functions and other communications provided by, for example, diagnosis module 605 and communication module 610. Control plane module 615 may terminate the control plane upon completion of one or more predetermined activities or functions such as, for example, completing a diagnosis, repair step, or maintenance step, completing a software update, receiving confirmation from a user remote storage device of completion of the diagnosis or maintenance protocol, or the like.

Maintenance module 620 may operate to facilitate one or more maintenance functions conducted on a remote storage device 105 internally and locally, or as provided by central service 110 from a remote location. Any one of the diagnosis modules 605, communication modules 610, control plane modules 615 and maintenance modules 620 may operate separately and distinct from each other, and/or may operate independently.

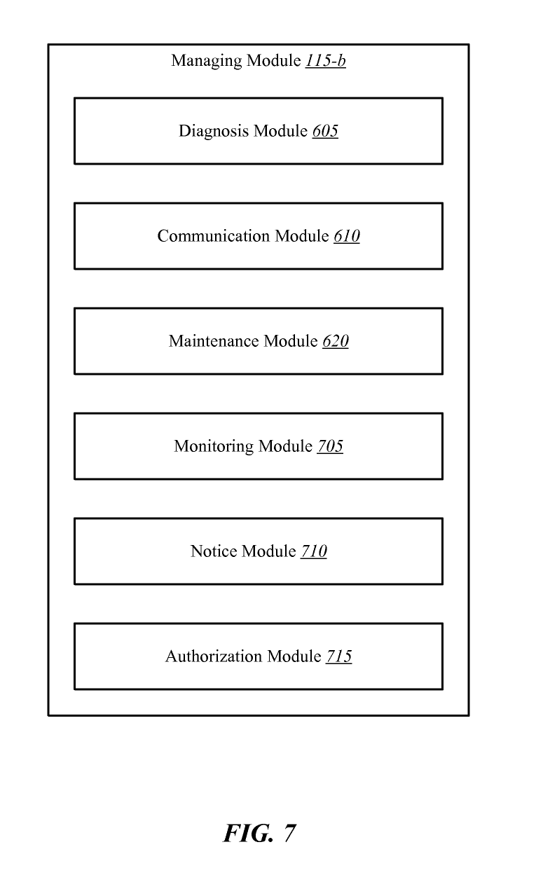

FIG. 7 is a block diagram illustrating an example managing module 115-b. Managing module 115-b may be one example of the managing module 115 described above with reference to FIGS. 1-5. Managing module 115-b may include, in addition to one or more of diagnosis module 605, communication module 610, and maintenance module 620, a monitoring module 705, a notice module 710, and an authorization module 715. Monitoring module 705 may operate to provide self-monitoring and/or evaluation of performance of a remote storage device 105 internally and locally. The monitoring may include, for example, determining an operational state of, for example, an operating system of a remote system device, a boot up status of the hard drive and/or operational system of the remote storage device 105, a responsiveness parameter (e.g., speed of operation, and the like) of remote storage device 105, and/or a user interaction with a remote storage device 105, via, for example, display 505 or user interface 510 (see FIG. 5). Diagnosis module 605 may diagnose one or more problems, statuses, or other relevant conditions based on data received from monitoring module 705.

Notice module 710 may operate to generate one or more notices based on at least one of outputs from diagnosis module 605 and data from monitoring module 705. The notice may be delivered to a user of the remote storage device 105 via, for example, display 505 (see FIG. 5). Additionally, or alternatively, the notice may be delivered to other persons via, for example, a mobile computing device (not shown) or central service 110 for user interface 510. The notice may be in the form of, for example, a text message, video message, audible alarm or the like. In some examples, the notice generated by notice module 710 may be communicated or delivered via communication module 610.

Authorization module 715 may receive permissions or authorizations from one or more users of the remote storage device 105 related to, for example, diagnosing, maintaining, repairing or otherwise communicating with the remote storage device by managing module 115 and/or central service 110. Authorization module 715 may prompt a user for authorization. Additionally, or alternatively, authorization module 715 may automatically apply a pre-entered authorization for certain functions and/or activities to a given circumstance based on one or more rules, criteria or the like.

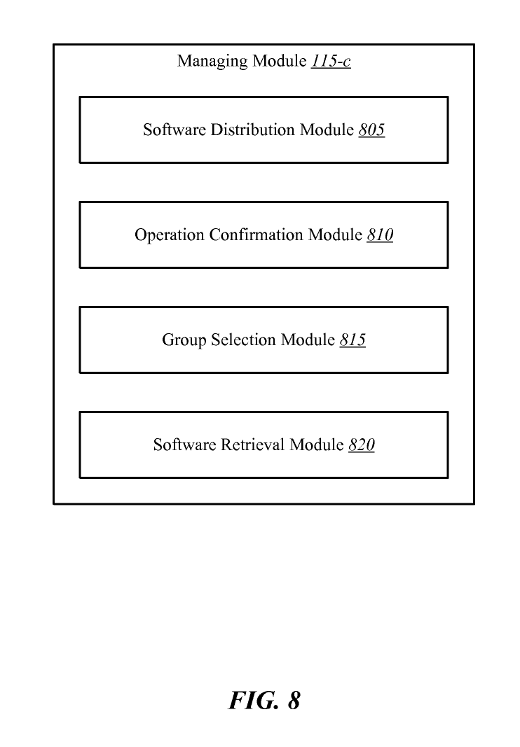

FIG. 8 is a block diagram illustrating an example managing module 115-c. Managing module 115-c may be one example of the managing module 115 described above with reference to FIGS. 1-5. Managing module 115-c may include a software distribution module 805, an operation confirmation module 810, a group selection module 815, and a software retrieval module 820. Managing module 115-c may be particularly useful for implementing the remote software updater embodiment described above with reference to at least FIG. 3.

Software distribution module 805 may operate to distribute software such as, for example, a software update or particular software version to one or more remote storage devices 105. Software distribution module 805 may distribute the software via, for example, pushing the software to one or more remote storage devices 105. Additionally, or alternatively, the software provided by software distribution module 805 may be made available, for example, at central service 110 and one or more remote storage devices 105 may actively reach out to central service 110 and download the software for use on remote storage device 105.

Software distribution module 805 may operate to distribute software based on any number of criteria such as, for example, a level of trust, a level of control, geographic proximity, and the like for the plurality of remote storage devices 105.

Operation confirmation module 810 may operate to confirm proper operation of software loaded onto any one of the plurality of remote storage devices 105. Operation confirmation module 810 may receive feedback from the remote storage devices 105 related to software operation. Alternatively, operation confirmation module 810 may reach out to and actively obtain or capture relevant information about operation of the software on any one of the remote storage devices. Operation confirmation module 810 may generate a notice in the event the software does or does not properly operate. In the event the software does not operate properly, operation confirmation module 810 may recommend withdrawing or recalling the software, sending of a software patch for correction of the software problems, or the like.

Group selection module 815 may assist in dividing the plurality of remote storage devices 105 into different groups or levels for purposes of distributing the software via software distribution module 805. Group selection module 815 may select and group together certain of the remote storage devices 105 based on, for example, a level of control available for controlling the remote storage device 105, a level of trust or certainty of obtaining feedback from the software, a geographic proximity to one or more other remote storage devices 105, and the like. A group selection module 815 may automatically consolidate a plurality of remote storage devices into a certain group based on preset criteria such as, for example, geographic proximity, date of purchase of the remote storage device, date on which the remote storage device is brought online and/or in an active state, a level of testing or review of software, an existing operative version of a given software on the remote storage devices, and the like.

In one example, a group selection module 815 may consolidate remote storage devices into groups based on an automated rollout plan wherein each group has in the range of 100 to 10,000 remote storage devices and the software is rolled out to each group in sequence until all of the remote storage devices (e.g., in the range of 100,000 to 1,000,000 devices) each receive a software update. As discussed above, some of the remote storage devices 105 may be grouped into a first level or group having complete control with a high level of trust or certainty that feedback will be received related to the software. This level or group of remote storage devices may be in physical control of the network operators. A second level or group of remote storage devices may be identified based on friends, family, or employees of the network operators and have a second, lower level of trust and/or control. A third or more group may be classified as a general population of the remote storage devices and may have the least amount of control/access and may have the lowest level of trust/certainty of being able to receive feedback related to the software.

Software retrieval module 820 may operate to retrieve software for any purpose such as, for example, inoperability of one or more features or functionality of the software that has been distributed via, for example, software distribution module 805. Software retrieval module 820 may reinstate operation of a previous version of the software upon retrieving a target software.

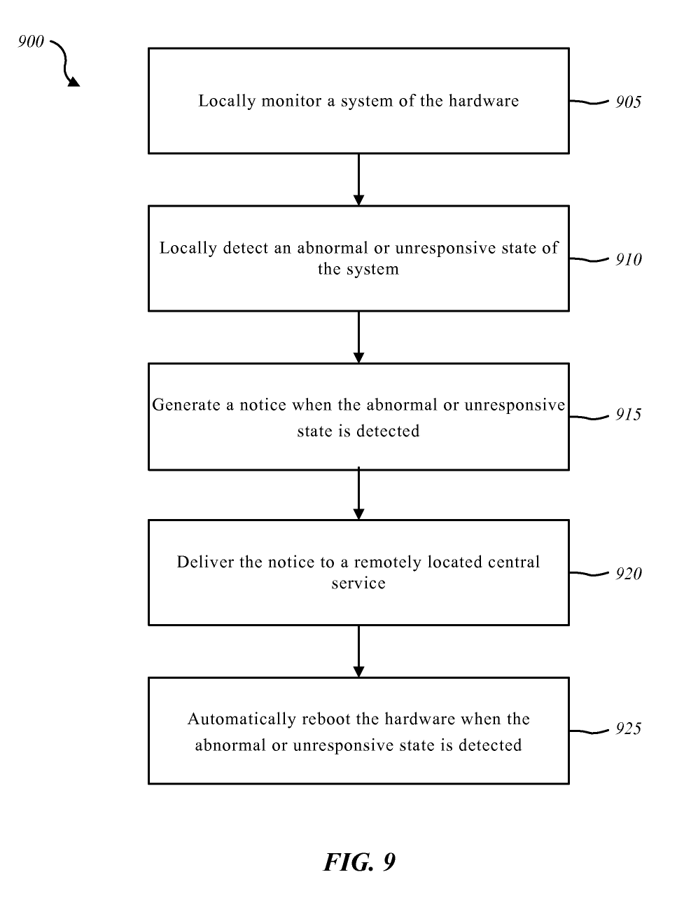

FIG. 9 is a block diagram illustrating one embodiment of a method 900 for remotely monitoring and/or managing hardware of at least one of a plurality of distributed remote storage devices. In some configurations, the method 900 may be implemented by the managing module 115 shown and described with reference to FIGS. 1-8. In other examples, method 900 may be performed generally by remote storage device 105 and/or central service 110 shown in FIGS. 1-5, or even more generally by the environments 100, 200, 300, 400, 500 shown in FIGS. 1-5.

At block 905, the method 900 includes locally monitoring a system (including, for example, an operating system and/or a core operating system) of the hardware. Block 910 includes locally detecting an abnormal or unresponsive state of the system. Block 915 includes generating a notice when the abnormal or unresponsive state is detected. Block 920 includes delivering the notice to a remotely located central service. At block 925 of method 900, the method includes automatically rebooting the hardware when the abnormal or unresponsive state is detected.

The method 900 may also include automatically rebooting after delivering the notice. The plurality of distributed remote storage devices may be controlled independently from control of the central service. The method 900 may include providing permission for the central service to perform diagnostics on the at least one of the storage devices. The method 900 may include receiving maintenance from the central service. The at least one of the storage devices in the central service may be part of a home automation system. The at least one of the storage devices may be part of a control panel of a home automation system.

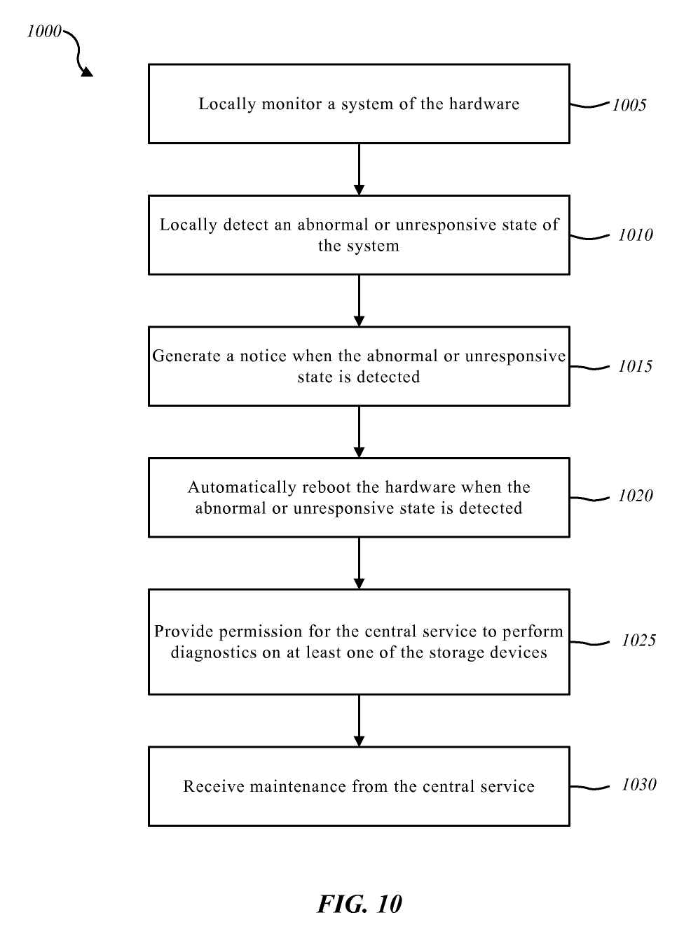

FIG. 10 is a flow diagram illustrating one embodiment of a method 1000 for managing hardware of at least one of a plurality of distributed remote storage devices. In some configurations, the method 1000 may be implemented by the managing module 115 shown and described with reference to FIGS. 1-8. In other examples, method 1000 may be performed generally by remote storage device 105 and/or central service 110 shown in FIGS. 1-5, or even more generally by environments 100, 200, 300, 400, 500 shown in FIGS. 1-5.

At block 1005, method 1000 includes locally monitoring a system (including, for example, an operating system and/or a core operating system) of the hardware. Block 1010 includes locally detecting an abnormal or unresponsive state of the system. Block 1015 includes generating a notice when the abnormal or unresponsive state is detected. Block 1020 of method 1000 includes automatically rebooting the hardware when the abnormal or unresponsive state is detected. Block 1025 includes providing permission for the central service to perform diagnostics on the at least one of the storage devices. Block 1030 includes receiving maintenance from the central service. The plurality of distributed remote storage devices may be controlled independently from control of the central service.

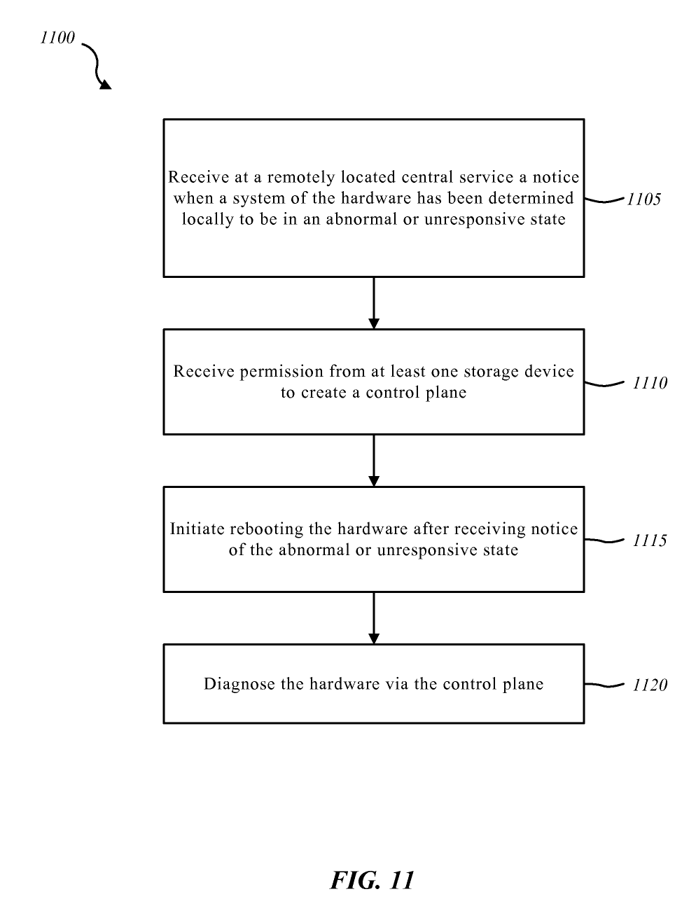

FIG. 11 is a flow diagram illustrating one embodiment of a method 1100 for remotely managing hardware of at least one of a plurality of distributed remote storage devices. In some configurations, the method 1100 may be implemented by the managing module 115 shown and described with reference to FIGS. 1-8. In other examples, method 1100 may be performed generally by remote storage device 105 and/or central service 110 shown in FIGS. 1-5, or even more generally by environments 100, 200, 300, 400, 500 shown in FIGS. 1-5.

At block 1105, method 1100 includes receiving at a remotely located central service a notice when a system (including, for example, an operating system and/or a core operating system) of the hardware has been determined locally to be in an abnormal or unresponsive state. Block 1110 includes receiving permission from the at least one of the storage devices to create a control plane. Block 1115 includes initiating rebooting of the hardware after receiving notice of the abnormal or unresponsive state. Block 1120 includes diagnosing the hardware via the control plane. Method 1100 may also include performing maintenance on a hardware via the control plane.

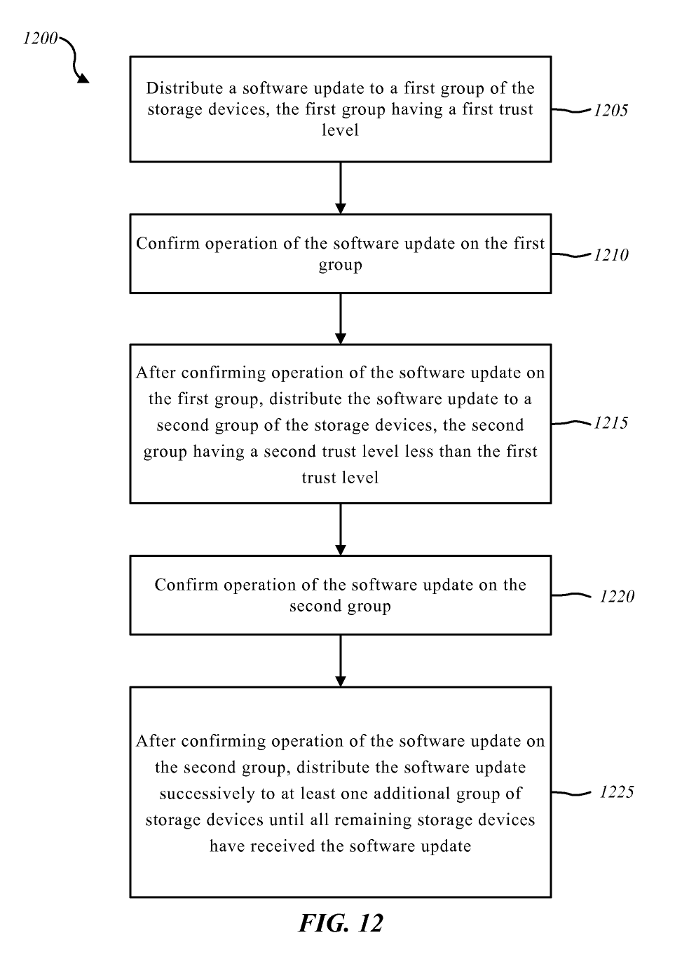

FIG. 12 is a flow diagram illustrating one embodiment of a method 1200 for remotely updating software in a plurality of distributed remote storage devices. In some configurations, the method 1200 may be implemented by the managing module 115 described with reference to FIGS. 1-8. In other examples, method 1200 may be performed generally by remote storage device 105 and/or central service 110 shown in FIGS. 1-5, or even more generally by environments 100, 200, 300, 400, 500 shown in FIGS. 1-5.

At block 1205, method 1200 includes distributing a software update to a first group of the storage devices, the first group having a first trust level. Block 1210 includes confirming operation of a software update on the first group. Block 1215 includes, after confirming operation of a software update on the first group, distributing the software update to a second group of the storage devices, the second group having a second trust level less than the first trust level. Block 1220 includes confirming operation of the software update on the second group. Block 1225 includes, after confirming operation of the software on the second group, distributing the software update successively to at least one additional group of the plurality of storage devices until all remaining storage devices have received the software update.

The number of storage devices in the first group may be less than the number of storage devices in the second group and be at least one additional group. Distributing the software update successively to the at least one additional group may include an automatic staged random delivery process. The automatic stage random delivery process may include controlling what percentage of the remaining storage devices receives the software update in a given time window and recording the percentage centrally. The method 1200 may include distributing another software update to the first group after confirming operation of the software update to the first group and before the software update has been distributed to all of the remaining storage devices. The method 1200 may include distributing multiple software updates simultaneously.

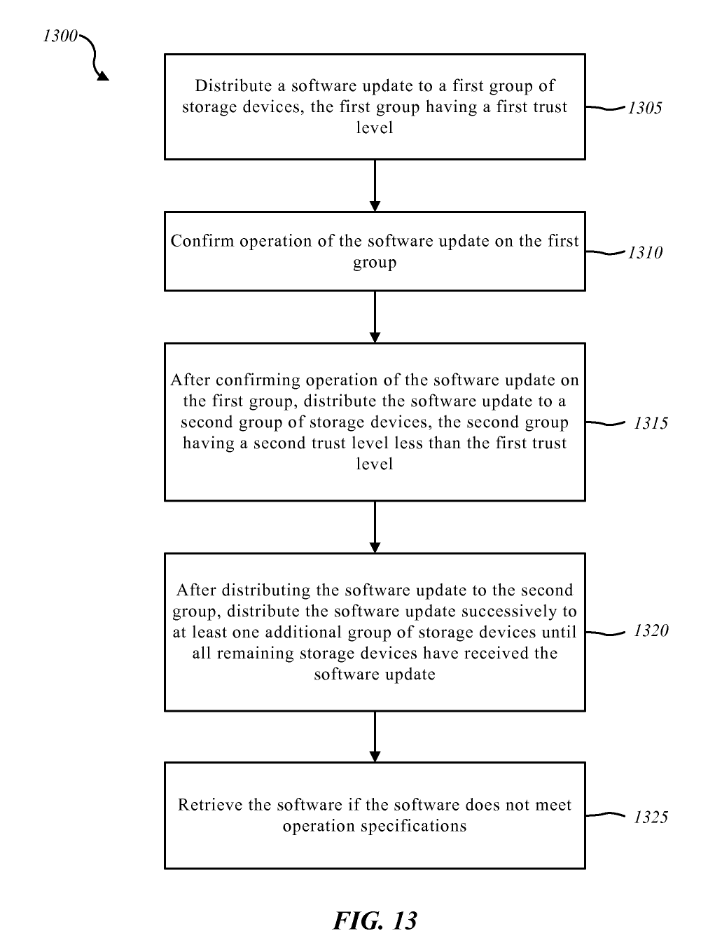

FIG. 13 is a flow diagram illustrating one embodiment of a method 1300 for updating software on a plurality of distributed remote storage devices. In some configurations, the method 1300 may be implemented by the managing module 115 shown and described with reference to FIGS. 1-8. In other examples, method 1300 may be performed generally by remote storage device 105 and/or central service 110 shown in FIGS. 1-5, or in more generally by environments 100, 200, 300, 400, 500 shown in FIGS. 1-5.

At block 1305, method 1300 includes distributing a software update to a first group of a storage devices, the first group having a first trust level. Block 1310 includes confirming operations of the software update on the first group. Block 1315 includes, after confirming operation of the software update on the first group, distributing the software update to a second group to the storage devices, the second group having a second trust level less than the first trust level. Block 1320 includes after distributing the software update to the second group, distributing the software update successively to at least one additional group of the plurality of the storage devices until all remaining storage devices have received the software update. Block 1325 includes retrieving the software if the software does not meet operations specifications.

The method 1300 may include distributing another software update to the first group after confirming operation of the software update on the first group and before the software update has been distributed to all of the remaining storage devices. Distributing the software update successively to at least one additional group may include an automatic staged random delivery process. The automatic staged random delivery process may include controlling what percentage of the remaining storage devices receives the software updates in a given time window or group, and recording the percentage centrally.

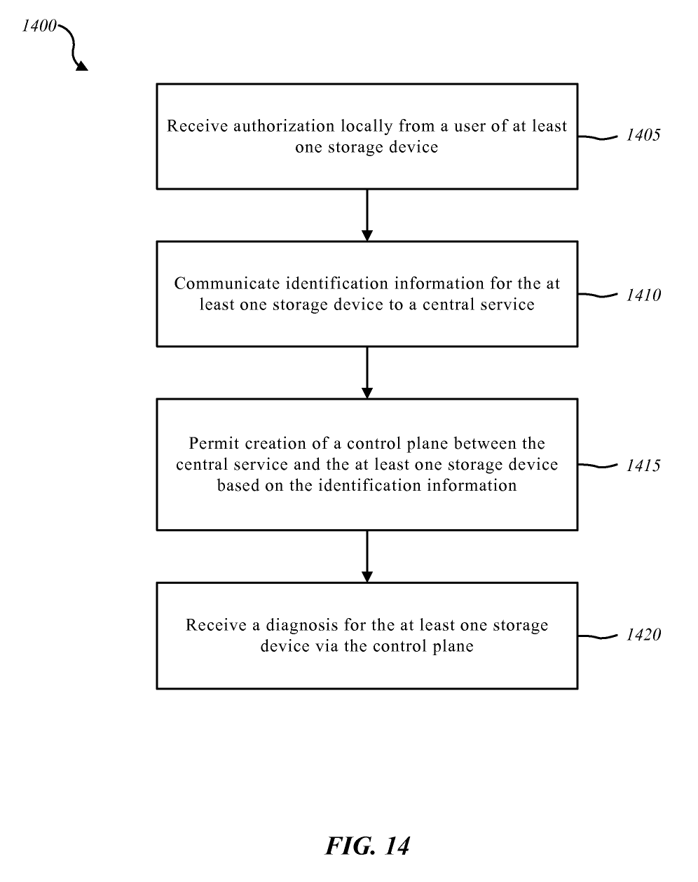

FIG. 14 is a flow diagram illustrating one embodiment of a method 1400 for remotely diagnosing at least one of a plurality of distributed remote storage devices. In some configurations, the method 1400 may be implemented by the managing module 115 shown and described as reference to FIGS. 1-8. In other examples, method 1400 may be performed generally by remote storage devices 105 and/or central service 110 show in FIGS. 1-5, or even more generally by environments 100, 200, 300, 400, 500 shown in FIGS. 1-5.

At block 1405, method 1400 includes receiving authorization locally from a user of at least one storage device. Block 1410 includes communicating identification information for the at least one of the storage devices to a central service. Block 1415 includes permitting creation of a control plane between the central service and the at least one of the storage devices based on the identification information. Block 1420 includes receiving a diagnosis of at least one storage device via the control plane.

Communicating identification information according to method 1400 may include periodically sending communications from at least one storage device to the central service. Communicating identification information may occur automatically upon receiving authorization locally from the user. Receiving authorization locally from the user may occur at set up of the at least one of the storage devices. The control plane may include remote control of the at least one of the storage devices by the central service. The method 1400 may include auditing tasks performed by the central service via the control plane. The control plane may include a secure shell (SSH) protocol.

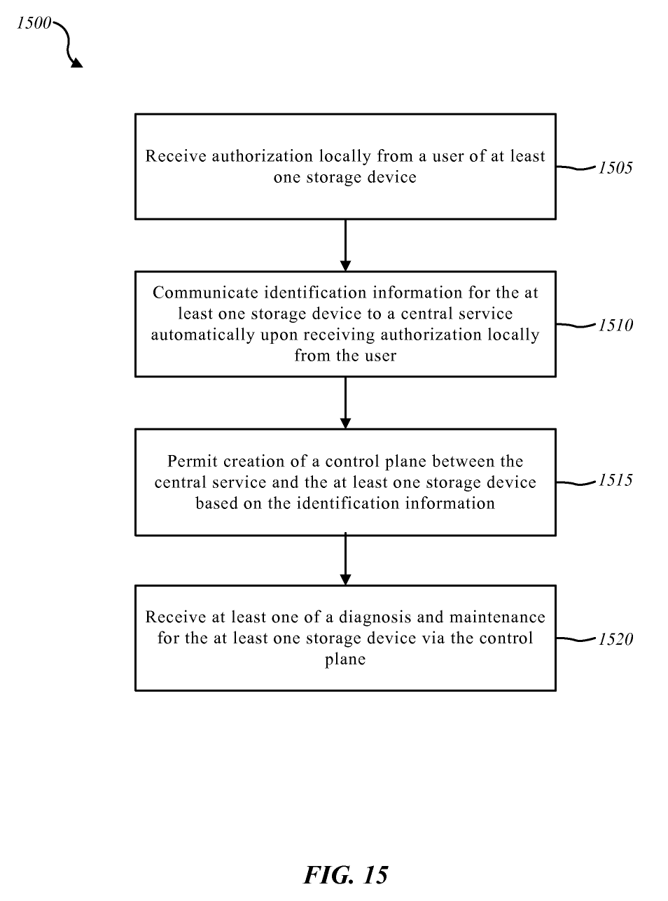

FIG. 15 is a flow diagram illustrating one embodiment of a method 1500 for remotely diagnosing at least one of a plurality of distributed remote storage devices. In some configurations, the method 1500 may be implemented by the managing module 115 shown and described with reference to FIGS. 1-8. In other examples, method 1500 may be performed generally by the remote storage devices 105 and/or central service 110 shown in FIGS. 1-5, or even more generally by the environments 100, 200, 300, 400, 500 shown in FIGS. 1-5.

At block 1505, method 1500 includes receiving authorization locally from a user of at least one storage device. Block 1510 includes communicating identification information for at least one storage device to a central service. Block 1515 includes permitting creation of a control plane between the central service and at least one storage device based on the identification information. Block 1520 includes receiving at least one of a diagnosis and maintenance for at least one storage device via the control plane. Communicating identification information may occur automatically upon receiving authorization locally from the user. The control plane may provide a remote control of the at least one of the storage devices by the central service. The control plane may include a secure shell (SSH) protocol.

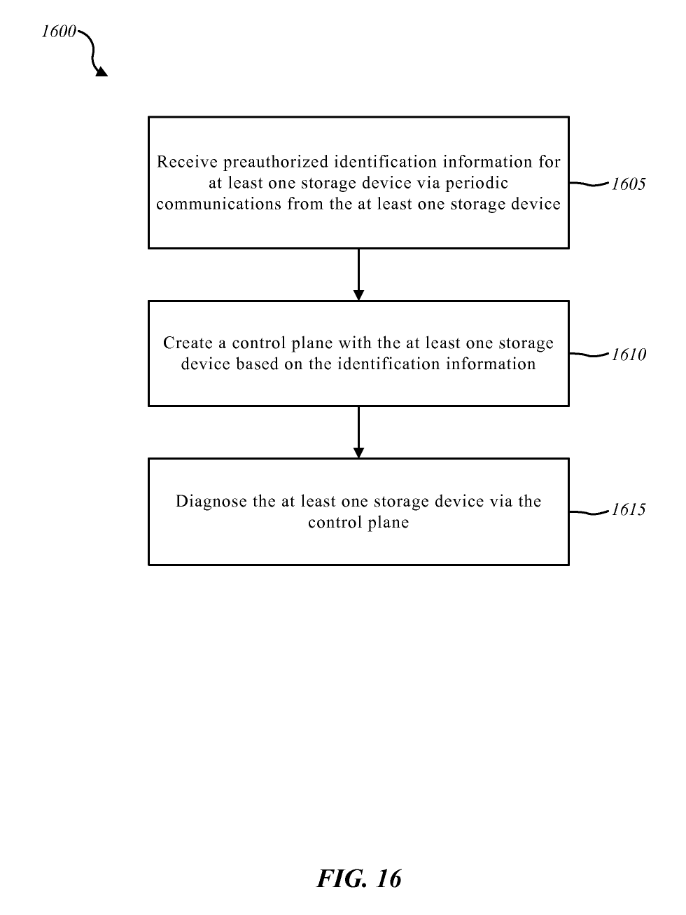

FIG. 16 is a flow diagram illustrating one embodiment of a method 1600 for remotely diagnosing at least one of a plurality of distributed remote storage devices. In some configurations, the method 1600 may be implemented by the managing module 115 shown and described with reference to FIGS. 1-8. In other examples, method 1600 may be performed generally by remote storage devices 105 and/or central service 110 shown in FIGS. 1-5, or even more generally by environments 100, 200, 300, 400, 500 shown in FIGS. 1-5.

At block 1605, method 1600 includes receiving pre-authorized identification information for the at least one of the storage devices via periodic communications from the at least one of the storage devices. Block 1610 includes creating a control plane with the at least one of the storage devices based on the identification information. Block 1615 includes diagnosing the at least one of the storage devices via the control plane. The control plane of method 1600 may include remote control of the at least one of the storage devices. The control plane may include a secure shell (SSH) protocol.

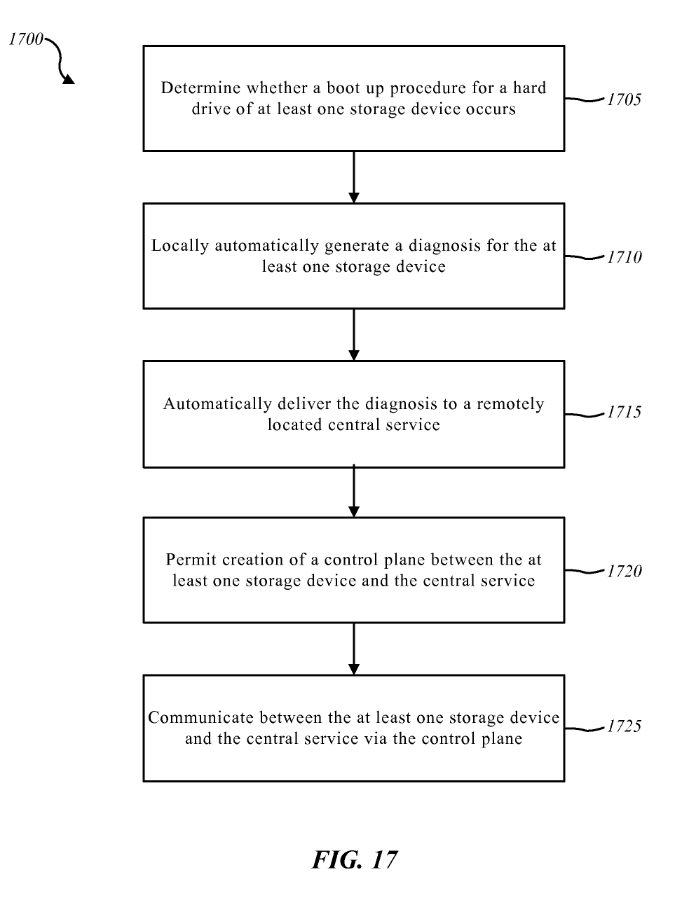

FIG. 17 is a flow diagram illustrating one embodiment of a method 1700 for locally diagnosing at least one of a plurality of distributed remote storage devices. In some configurations, the method 1700 may be implemented by the managing module 115 shown and described as reference to FIGS. 1-8. In other examples, method 1700 may be performed generally by remote storage devices 105 and/or central service 110 shown in FIGS. 1-5, or even more generally by environments 100, 200, 300, 400, 500 shown in FIGS. 1-5.

Block 1705 of method 1700 includes determining whether a boot up procedure for a hard drive of at least one storage device occurs. Block 1710 includes locally automatically generating a diagnosis for the at least one of the storage devices. Block 1715 includes automatically delivering the diagnosis to a remotely located central service. Block 1720 includes permitting creation of a control plane to the at least one of the storage devices and the central service. Block 1725 includes communicating between the at least one of the storage devices and the central service via the control plane.

Method 1700 may also include initiating a boot up procedure for a system (including, for example, an operating system and/or a core operating system) of at least one storage device, and initiating the boot up procedure for a hard drive of at least one storage device, wherein the diagnosis relates to a failure of the hard drive to boot up. Method 1700 may include receiving confirmation of the diagnosis from the central service. Method 1700 may include receiving maintenance from the central service via the control plane.

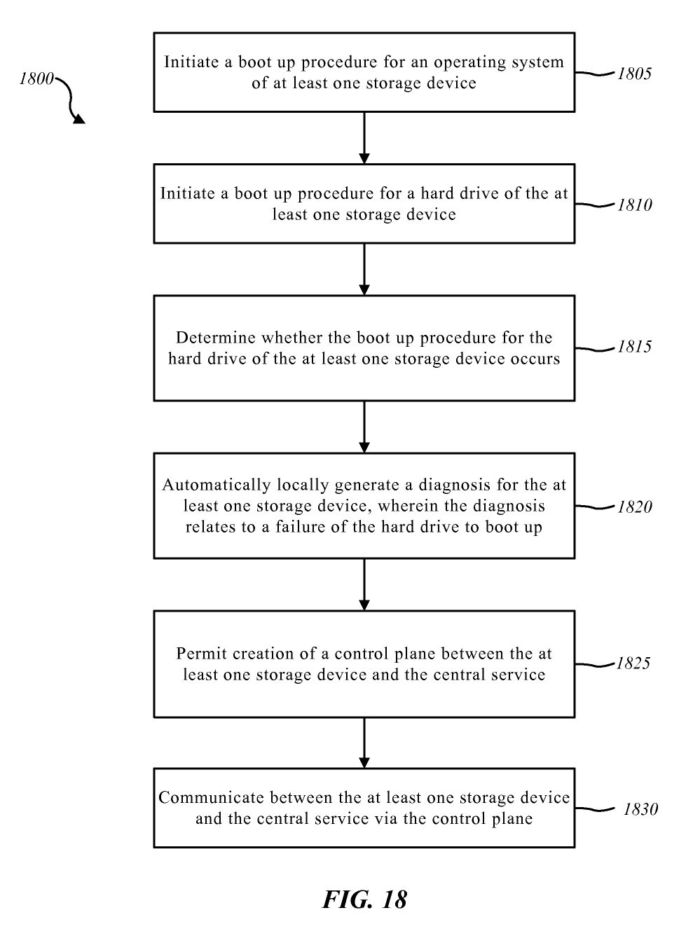

FIG. 18 is a flow diagram illustrating one embodiment of a method 1800 for locally diagnosing at least one of a plurality of distributed remote storage devices. In some configurations, the method 1800 may be implemented by the managing module 115 shown and described with reference to FIGS. 1-8. In other examples, method 1800 may be performed generally by remote storage devices 105 and/or central service 110 shown in FIGS. 1-5, or even more generally by environments 100, 200, 300, 400, 500 shown in FIGS. 1-5.

At block 1805, method 1800 includes initiating the boot up procedure for a system (including, for example, an operating system and/or a core operating system) of the at least one of the storage devices. Block 1810 includes initiating the boot up procedure for a hard drive of at least one storage device. Block 1815 includes determining whether a boot up procedure for a hard drive of the at least one of the storage devices occurs. Block 1820 includes automatically locally generating a diagnosis for the at least one of the storage devices, wherein the diagnosis relates to a failure of the hard drive to boot up. Block 1825 includes permitting creation of a control plane between the at least one of the storage devices and the central service. Block 1830 includes communicating between the at least one of the storage devices and the central service via the control plane. The method 1800 may also include receiving from the central service confirmation of the diagnosis via the control plane. Method 1800 may include receiving maintenance from the central service via the control plane.

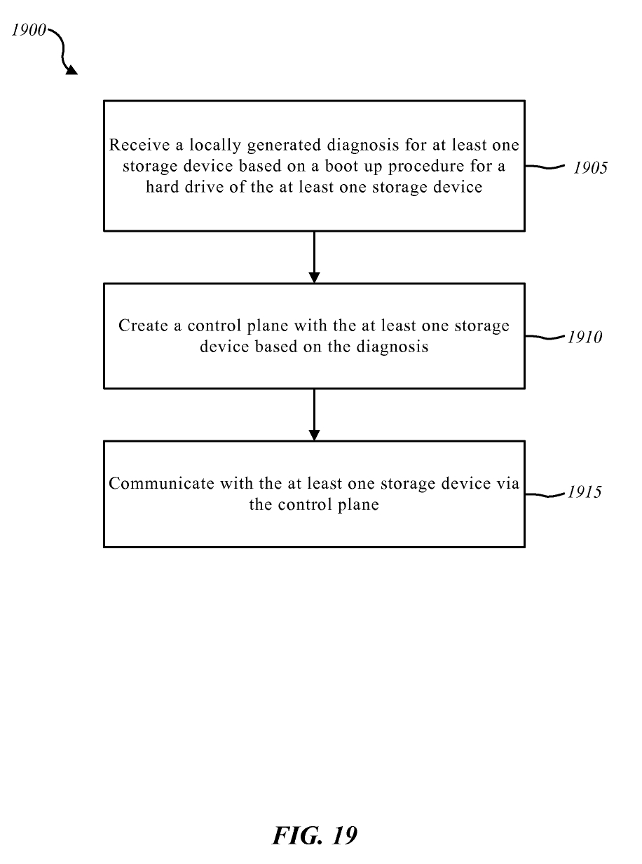

FIG. 19 is a flow diagram illustrating one embodiment of a method 1900 for locally diagnosing at least one of a plurality of distributed remote storage devices. In some configurations, the method 1900 may be implemented by the managing module 115 described and referenced as to FIGS. 1-8. In other examples, method 1900 may be performed generally by remote storage devices 105 and/or central service 110 shown in FIGS. 1-5, or even more generally by environments 100, 200, 300, 400, 500 shown in FIGS. 1-5.

At block 1905, method 1900 includes receiving a locally generated diagnosis for the at least one of the storage devices based on a boot up procedure for a hard drive of the at least one of the storage devices. Block 1910 includes creating a control plane with the at least one of the storage devices based on the diagnosis. Block 1915 includes communicating with the at least one of the storage devices via the control plane. The diagnosis may relate to a failure of the hard drive to boot up. The method 1900 may include transmitting confirmation of the diagnosis to the at least one of the storage devices. Method 1900 may include providing maintenance for the at least one of the storage devices via the control plane.

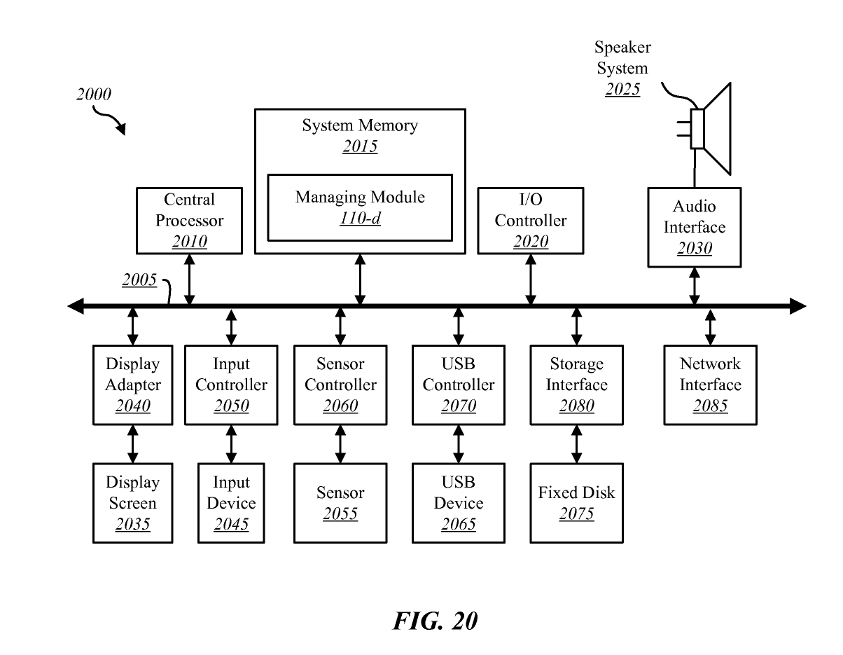

FIG. 20 depicts a block diagram of a controller 2000 suitable for implementing the present systems and methods. In one configuration, controller 2000 includes a bus 2005 which interconnects major subsystems of controller 2000, such as a central processor 2010, a system memory 2015 (typically RAM, but which may also include ROM, flash RAM, or the like), an input/output controller 2020, an external audio device, such as a speaker system 2025 via an audio output interface 2030, an external device, such as a display screen 2035 via display adapter 2040, an input device 2045 (e.g., remote control device interfaced with an input controller 2050), multiple USB devices 2065 (interfaced with a USB controller 2070), and a storage interface 2080. Also included are at least one sensor 2055 connected to bus 2005 through a sensor controller 2060 and a network interface 2085 (coupled directly to bus 2005).

Bus 2005 allows data communication between central processor 2010 and system memory 2015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the managing module 115-d to implement the present systems and methods may be stored within the system memory 2015. Applications resident with controller 2000 are generally stored on and accessed via a non-transitory computer readable medium, such as a hard disk drive (e.g., fixed disk drive 2075) or other storage medium. Additionally, applications can be in the form of electronic signals modulated in accordance with the application and data communication technology when accessed via network interface 2085.

Storage interface 2080, as with the other storage interfaces of controller 2000, can connect to a standard computer readable medium for storage and/or retrieval of information, such as a fixed disk drive 2075. Fixed disk drive 2075 may be a part of controller 2000 or may be separate and accessed through other interface systems. Network interface 2085 may provide a direct connection to a remote server via a direct network link to the Internet via a POP (point of presence). Network interface 2085 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 2000 wirelessly via network interface 2085.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 20 need not be present to practice the present systems and methods. The devices and subsystems can be interconnected in different ways from that shown in FIG. 20. The aspect of some operations of a system such as that shown in FIG. 20 are readily known in the art and are not discussed in detail in this application. Code to implement the present disclosure can be stored in a non-transitory computer-readable medium such as one or more of system memory 2015 or fixed disk drive 2075. The operating system provided on controller 2000 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer implemented method for remotely managing hardware of at least one of a plurality of distributed remote storage devices, comprising:
locally monitoring a system of the hardware;
locally detecting an abnormal or unresponsive state of the system;
generating a notice when the abnormal or unresponsive state is detected;
delivering the notice to a remotely located central service; and
automatically rebooting the hardware when the abnormal or unresponsive state is detected.

2. The method of claim 1, wherein automatically rebooting occurs after delivering the notice and the system includes a core operating system.

3. The method of claim 1, wherein the at least one of the storage devices is controlled independently from control of the central service.

4. The method of claim 1, further comprising:
providing permission for the central service to perform diagnostics on the at least one of the storage devices.

5. The method of claim 1, further comprising:
receiving maintenance from the central service.

6. The method of claim 1, wherein the at least one of the storage devices and the central service are part of a home automation system.

7. The method of claim 1, wherein the at least one of the storage devices is part of a control panel of a home automation system.

8. An apparatus for remotely managing hardware of at least one of a plurality of distributed remote storage devices, comprising:
a processor;
a memory in electronic communication with the processor; and
instructions stored in the memory, the instructions being executable by the processor to:
locally monitor a system of the hardware;
locally detect an abnormal or unresponsive state of the system;
generate a notice when the abnormal or unresponsive state is detected; and
automatically reboot the hardware when the abnormal or unresponsive state is detected.

9. The apparatus of claim 8, wherein the plurality of distributed remote storage devices are controlled independently from control of a central service.

10. The apparatus of claim 8, wherein the instructions are executable by the processor to:
provide permission for a central service to perform diagnostics on the at least one of the storage devices.

11. The apparatus of claim 8, wherein the instructions are executable by the processor to:
receive maintenance from a central service.

12. A computer implemented method for remotely managing hardware of at least one of a plurality of distributed remote storage devices, comprising:
receiving at a remotely located central service a notice when a system of the hardware has been determined locally to be in an abnormal or unresponsive state;
receiving permission from the at least one of the storage devices to create a control plane;
initiating rebooting of the hardware after receiving notice of the abnormal or unresponsive state; and
diagnosing the hardware via the control plane.

13. The method of claim 12, further comprising:
performing maintenance on the hardware via the control plane.

14. A computer implemented method for remotely updating software on a plurality of distributed remote storage devices, comprising:
distributing a software update to a first group of the storage devices, the first group having a first trust level;
confirming operation of the software update on the first group;
after confirming operation of the software update on the first group, distributing the software update to a second group of the storage devices, the second group having a second trust level less than the first trust level;
confirming operation of the software update on the second group; and
after confirming operation of the software update on the second group, distributing the software update successively to at least one additional group of the plurality of distributed remote storage devices until all remaining storage devices have received the software update.

15. The method of claim 14, wherein the number of storage devices in the first group is less than the number of storage devices in the second group and the at least one additional group.

16. The method of claim 14, wherein distributing the software update successively to the at least one additional group includes an automatic staged random delivery process.

17. The method of claim 16, wherein the automatic staged random delivery process includes controlling what percentage of the remaining storage devices receives the software update in a given time window and recording the percentage centrally.

18. The method of claim 14, further comprising:
distributing another software update to the first group after confirming operation of the software update on the first group and before the software update has been distributed to all of the remaining storage devices.

19. The method of claim 14, further comprising:
distributing multiple software updates simultaneously.

20. An apparatus for remotely updating software on a plurality of distributed remote storage devices, comprising:
a processor;
a memory in electronic communication with the processor; and
instructions stored in the memory, the instructions being executable by the processor to:
distribute a software update to a first group of the storage devices, the first group having a first trust level;
confirm operation of the software update on the first group;
after confirming operation of the software update on the first group, distribute the software update to a second group of the storage devices, the second group having a second trust level less than the first trust level; and
after distributing the software update to the second ground, distribute the software update successively to at least one additional group of the plurality of distributed remote storage devices until all remaining storage devices have received the software update.

21. The apparatus of claim 20, wherein the number of storage devices in the first group is less than the number of storage devices in the second group and the at least one additional group.

22. The apparatus of claim 20, wherein distributing the software update successively to the at least one additional group includes an automatic staged random delivery process.

23. The apparatus of claim 22, wherein the automatic staged random delivery process includes controlling what percentage of the remaining storage devices receives the software update in a given time window and recording the percentage centrally.

24. The apparatus of claim 20, wherein the instructions are executable by the processor to:
distribute another software update to the first group after confirming operation of the software update on the first group and before the software update has been distributed to all of the remaining storage devices.

25. The apparatus of claim 20, wherein the instructions are executable by the processor to:
retrieve the software if the software does not meet operation specifications.

26. A computer implemented method for remotely diagnosing at least one of a plurality of distributed remote storage devices, comprising:
receiving authorization locally from a user of the at least one of the storage devices;
communicating identification information for the at least one of the storage devices to a central service;
permitting creation of a control plane between the central service and the at least one of the storage devices based on the identification information; and
receiving a diagnosis for the at least one of the storage devices via the control plane.

27. The method of claim 26, wherein communicating identification information includes periodically sending communications from the at least one storage device to the central service.

28. The method of claim 26, wherein communicating identification information occurs automatically upon receiving authorization locally from the user.

29. The method of claim 26, wherein receiving authorization locally from the user occurs at set up of the at least one of the storage devices.

30. The method of claim 26, wherein the control plane includes remote control of the at least one of the storage devices by the central service.

31. The method of claim 26, further comprising:
auditing tasks performed by the central service via the control plane.

32. The method of claim 26, wherein the control plane includes a secure shell (SSH) protocol.

33. An apparatus for remotely diagnosing at least one of a plurality of distributed remote storage devices, comprising:
a processor;
a memory in electronic communication with the processor; and
instructions stored in the memory, the instructions being executable by the processor to:
receive authorization locally from a user of the at least one of the storage devices;
communicate identification information for the at least one of the storage devices to a central service;
permit creation of a control plane between the central service and the at least one of the storage devices based on the identification information; and
receive at least one of a diagnosis and maintenance for the at least one of the storage devices via the control plane.

34. The apparatus of claim 33, wherein communicating identification information occurs automatically upon receiving authorization locally from the user.

35. The apparatus of claim 33, wherein the control plane provides remote control of the at least one of the storage devices by the central service.

36. The apparatus of claim 33, wherein the control plane includes a secure shell (SSH) protocol.

37. A computer implemented method for remotely diagnosing at least one of a plurality of distributed remote storage devices, comprising:
receiving pre-authorized identification information for the at least one of the storage devices via periodic communications from the at least one of the storage devices;
creating a control plane with the at least one of the storage devices based on the identification information; and
diagnosing the at least one of the storage devices via the control plane.

38. The method of claim 37, wherein the control plane includes remote control of the at least one of the storage devices.

39. The method of claim 37, wherein the control plane includes a secure shell (SSH) protocol.

40. A computer implemented method for locally diagnosing at least one of a plurality of distributed remote storage devices, comprising:
determining whether a boot up procedure for a hard drive of the at least one of the storage devices occurs;
locally automatically generating a diagnosis for the at least one of the storage devices;
automatically delivering the diagnosis to a remotely located central service;
permitting creation of a control plane between the at least one of the storage devices and the central service; and
communicating between the at least one of the storage devices and the central service via the control plane.

41. The method of claim 40, further comprising:
initiating a boot up procedure for a system of the at least one of the storage devices; and
initiating the boot up procedure for the hard drive of the at least one of the storage devices;
wherein the diagnosis relates to a failure of the hard drive to boot up.

42. The method of claim 40, further comprising:
receiving confirmation of the diagnosis from the central service.

43. The method of claim 40, further comprising:
receiving maintenance from the central service via the control plane.

44. An apparatus for locally diagnosing at least one of a plurality of distributed remote storage devices, comprising:
a processor;
a memory in electronic communication with the processor; and
instructions stored in the memory, the instructions being executable by the processor to:
determine whether a boot up procedure for a hard drive of the at least one of the storage devices occurs;
automatically locally generate a diagnosis for the at least one of the storage devices;
permit creation of a control plane between the at least one of the storage devices and a central service; and
communicate between the at least one of the storage devices and the central service via the control plane.

45. The apparatus of claim 44, wherein the instructions are executable by the processor to:
initiate a boot up procedure for a system of the at least one of the storage devices; and
initiate the boot up procedure for the hard drive of the at least one of the storage devices;
wherein the diagnosis relates to a failure of the hard drive to boot up.

46. The apparatus of claim 44, wherein the instructions are executable by the processor to:
receive from the central service confirmation of the diagnosis via the control plane.

47. The apparatus of claim 44, wherein the instructions are executable by the processor to:
receive maintenance from the central service via the control plane.

48. A computer implemented method for locally diagnosing at least one of a plurality of distributed remote storage devices, comprising:
receiving a locally generated diagnosis for the at least one of the storage devices based on a boot up procedure for a hard drive of the at least one of the storage devices;
creating a control plane with the at least one of the storage devices based on the diagnosis; and
communicating with the at least one of the storage devices via the control plane.

49. The method of claim 48, wherein the diagnosis relates to a failure of the hard drive to boot up.

50. The method of claim 48, further comprising:
transmitting confirmation of the diagnosis to the at least one of the storage devices.

51. The method of claim 48, further comprising:
providing maintenance for the at least one of the storage devices via the control plane.
